(19) United States
(12) Patent Application Publication
(10) Pub. No.: US 2025/0354090 A1
(43) Pub. Date: Nov. 20, 2025

(54) Soap Composition and Process of Preparing

(71) Applicant: Edite DaSilva, Toronto (CA)

(72) Inventor: Edite DaSilva, Toronto (CA)

(21) Appl. No.: 18/667,636

(22) Filed: May 17, 2024

(51) Int. Cl. C11D 3/20; C11D 3/22; C11D 3/48

(52) U.S. Cl. CPC C11D 3/2079; C11D 3/201; C11D 3/221; C11D 3/48

(57) ABSTRACT

A soap composition is disclosed. In an embodiment, the soap composition includes 60% to 75% by weight of the total composition of vinegar. The soap composition further includes 5% to 20% by weight of the total composition of a sugar solution, and 10% to 15% by weight of the total composition of surfactants. Additionally, the soap composition further includes 5% to 10% by weight of the total composition of isopropyl alcohol.

### BACKGROUND OF THE INVENTION

The present disclosure relates, generally, to soaps, and more particularly, the present disclosure pertains to a soap composition and process of preparing the same.

Conventionally, preparing soaps for cleaning purposes presents some challenges, especially, when preparing from simple ingredients. For example, achieving the desired consistency and texture can be tricky without the use of specialized equipment or additives. Simple ingredients like oils require precise measurements and careful handling to ensure the soap turns out well. Further, achieving the desired scent and color can be limited when using only basic ingredients. Fragrance oils and colorants often enhance the appeal of the soap, but without them, achieving a pleasing aroma and aesthetic can be more challenging. Furthermore, ensuring the soap is gentle and suitable for different skin types can be a concern. As such, although making soap from simple ingredients is possible, it requires attention to detail and experimentation to overcome these challenges and create a high-quality product.

### SUMMARY OF THE INVENTION

According to an aspect of the disclosure, a soap composition is provided. The soap composition includes 60% by weight of the total composition of vinegar. The composition further includes 10% by weight of the total composition of isopropyl alcohol. The composition further includes 10% by weight of the total composition of surfactants.

In an embodiment, the soap composition further includes 20% by weight of the total composition of a sugar solution.

In an embodiment, the sugar solution includes a mixture of water and sugar. In an embodiment, the sugar is fructose.

In an embodiment, the sugar is derived from starch of corn.

According to an aspect of the disclosure, another soap composition is provided. The soap composition includes 60% by weight of the total composition of vinegar, 10% by weight of the total composition of surfactants, and 20% by weight of the total composition of a sugar solution.

In an embodiment, the above soap composition further includes 10% by weight of the total composition of alcohol.

In an embodiment, the alcohol of the above soap composition is isopropyl alcohol.

According to an aspect of the disclosure, yet another soap composition is provided. The soap composition includes 10% by weight of the total composition of surfactants, 20% by weight of the total composition of a sugar solution, and 10% by weight of the total composition of alcohol.

In an embodiment, the above soap composition further includes 60% by weight of the total composition of vinegar.

In an embodiment, the above soap composition further includes

According to an aspect of the disclosure, yet another soap composition is provided. The soap composition includes 75% by weight of the total composition of vinegar, 5% by weight of the total composition of isopropyl alcohol, and 15% by weight of the total composition of surfactants.

In an embodiment, the above soap composition further includes 5% by weight of the total composition of a sugar solution.

In an embodiment, the vinegar includes 5% by weight of the vinegar composition of acetic acid.

In an embodiment, the isopropyl alcohol has 99.9% strength.

According to an aspect of the disclosure, a process of producing a soap composition is provided. The process includes adding 60% to 75% by weight of the total composition of vinegar to a mixing chamber. The process further includes adding and mixing by shaking 5% to 20% by weight of the total composition of a sugar solution in the mixing chamber for a predetermined time period. The process further includes adding and mixing by shaking 10% to 15% by weight of the total composition of surfactants in the mixing chamber, to obtain the soap composition.

In an embodiment, the process further includes, prior to adding the surfactants, adding and mixing 5% to 10% by weight of the total composition of isopropyl alcohol, in the mixing chamber.

For a more complete understanding of the present invention, reference is made to the following detailed description and accompanying drawings. In the drawing, like reference characters refer to like parts throughout the views.

### BRIEF DESCRIPTION OF FIGURES

FIG. 1 illustrates a flowchart of a process of producing a soap composition, in accordance with an aspect of the disclosure.

### DETAILED DESCRIPTION

According to an aspect of the disclosure, a soap composition is provided. The soap composition may include 60% to 75% by weight of the total composition of vinegar. As will be appreciated by those skilled in the art, vinegar is primarily composed of acetic acid and water, and may be produced through the fermentation of ethanol, typically derived from sugars in various natural sources like fruits, grains, or alcohol. Vinegar is used in cooking, cleaning, and as a food preservative. Further, owing to its antimicrobial properties, vinegar is used for removing stains, deodorizing surfaces, and disinfecting.

Further, in an embodiment, the vinegar used for the soap composition may be white vinegar. As will be understood, the white vinegar may be a solution typically consisting of 4-7% acetic acid and 93-96% water. In an embodiment, the vinegar used in the soap composition may include 5% acetic acid. Acetic acid, systematically named ‘ethanoic acid, is an acidic, colorless liquid and organic compound. Chemical formula of acetic acid is CH3COOH and chemically represented as below:

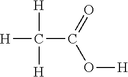

In some example embodiments, a commercial white vinegar with tradename “Selections” may be used as the vinegar.

The soap composition may further include 10% to 15% by weight of the total composition of surfactants. As will be appreciated by those skilled in the art, the surfactant may include molecules that lower the surface tension between two substances, such as a liquid and a solid or another liquid. The surfactant may achieve this by accumulating at the interface and altering the properties of the surface. As such, the surfactants are constituents of detergents, emulsifiers, foaming agents, and dispersants, and may be used for facilitating processes like cleaning, wetting, and stabilizing emulsions. As such, the surfactant used in the soap composition may be selected from commonly available commercial detergents. By way of an example, the detergent with tradename “Tide” may be used. Typically, a commercial detergent like “Tide” may have a composition as described below.

The commercial detergent (or, simply the detergent) may include surfactants that may be the primary cleaning agents, and help to lift and remove dirt, oil, and stains from fabrics. Some example surfactants used may include ‘alkyl sulfates’ and ‘ethoxylated alcohol’. The detergent may further include builders that help to enhance the cleaning efficiency of the detergent by softening water, preventing the redeposition of soil onto fabrics, and improving detergent performance across a range of water hardness levels. Some example builders may include ‘sodium carbonate’ or ‘soda ash’, ‘sodium citrate’, etc. The detergent may further include enzymes that are biological molecules that break down specific types of stains and soils, such as proteins, starches, and fats. Some example enzymes used in the detergent may include ‘protease’, ‘amylase’, and ‘lipase’. Furthermore, the detergent may include bleach to help remove stains and brighten whites. For example, ‘chlorine’ bleach or ‘oxygen’ bleach (i.e. ‘percarbonate’) are some of the examples of the bleach. Additionally, the detergent may also include stabilizers and pH adjusters to stabilize the detergent formulation and maintain the desired pH level for optimal cleaning performance. Moreover, some other constituents of the detergent may include fillers, anti-redeposition agents, and fabric softeners, depending on the specific product and formulation. It should be noted that instead of using the detergents which are combination of multiple constituents as described above, pure surfactants may also be used.

The soap composition may further include 5% to 10% by weight of the total composition of alcohol. In an embodiment, the alcohol may be ‘isopropyl alcohol’.

Chemical formula of isopropyl alcohol’ is (CH3)2CHOH), and is chemically represented as below:

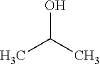

Isopropyl alcohol, also known as rubbing alcohol, is a clear, colorless liquid and is miscible in water. Isopropyl alcohol serves as a solvent in household and industrial applications, and may be utilized as a cleaner for electronics, lenses, and mechanical parts due to its ability to dissolve oils, greases, and dirt without leaving residues. Further, isopropyl alcohol is commonly used as a disinfectant and antiseptic agent due to its ability to kill bacteria, viruses, and fungi on surfaces and skin.

Additionally or optionally, the soap composition may further include 5% to 20% by weight of the total composition of a sugar solution. In some example embodiments, a commercial sugar-based beverage such as “Coca Cola” may be used as the sugar solution. As is generally known, the ingredients of the beverage “Coca-Cola” may include carbonated water and sugar or a sweetener. Typically, the “Coca-Cola” beverage may include a sweetening agent, such as high fructose corn syrup or sucrose, to give the beverage its sweet taste. Additionally, the beverage “Coca-Cola” may also include caffeine which is a stimulant that provides a mild energy boost and contributes to the taste profile. Also, some amount of phosphoric acid may also be found in the beverage “Coca-Cola” for flavoring and to act as a preservative. Further, some natural flavors, colors, and citric acid may also be present to create its distinctive taste. Typically, the proportion of sugar may be about 11 grams (of sugar) per 100 grams of the beverage “Coca-Cola”. It should be noted that that beverage “Coca-Cola” may be used for providing the sugar solution, and, therefore, any sugar solution may be used as well for the purpose of the present subject matter. For example, a sugar solution prepared by mixing sugar in water in the same proportions as above (i.e. 11 grams of sugar per 100 grams of solution) may be used.

As such, the sugar solution may include a mixture of water and sugar. In an embodiment, the sugar may be ‘fructose’. As will be understood, the fructose is a simple sugar that may be naturally found in fruits, honey, and some root vegetables, and is a common dietary monosaccharide. Fructose is a 6-carbon polyhydroxyketone. Crystalline fructose adopts a cyclic six-membered structure, called β-d-fructopyranose, owing to the stability of its hemiketal and internal hydrogen-bonding. In solution, fructose may exist as an equilibrium mixture of the tautomers β-d-fructopyranose, β-d-fructofuranose, α-d-fructofuranose, α-d-fructopyranose and keto-d-fructose (the non-cyclic form). The chemical formula of D-fructose is C6H12O6, and represented as below:

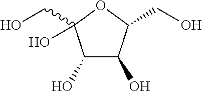 [SMILES: OC[C@H]1OC(O)(CO)[C@@H](O)[C@@H]1O]

In an embodiment, the sugar (i.e. the fructose) may be derived from starch of corn (also known as maize). However, it may be possible to use fructose derived from other natural sources as well.

Therefore, a composition of the soap as described above is represented in Table-1 below.

TABLE 1

| Constituent | Range of proportion |
|---|---|
| Vinegar | 60% to 75% by weight of the total |
| | composition |
| Sugar solution | 5% to 20% by weight of the total composition |
| Surfactant | 10% to 15% by weight of the total |
| | composition |
| Isopropyl alcohol | 5% to 10% by weight of the total composition |

According to an aspect of the disclosure, another soap composition is provided. This soap composition may include 60% by weight of the total composition of vinegar, 10% by weight of the total composition of surfactants, and 20% by weight of the total composition of a sugar solution. For example, the alcohol of the above soap composition may be isopropyl alcohol. In an example embodiment, the vinegar includes 5% by weight of the vinegar composition of acetic acid. Further, in an example embodiment, the isopropyl alcohol has 99.9% strength.

Additionally or optionally, the above soap composition further include 10% by weight of the total composition of alcohol.

Therefore, a composition of the soap as described above is represented in Table-2 below.

TABLE 2

| Constituent | Range of proportion |
|---|---|
| Vinegar | 60% by weight of the total composition |
| Sugar solution | 20% by weight of the total composition |
| Surfactant | 10% by weight of the total composition |
| Alcohol (optional) | 10% by weight of the total composition |

According to an aspect of the disclosure, yet another soap composition is provided. This soap composition may include 10% by weight of the total composition of surfactants, 20% by weight of the total composition of a sugar solution, and 10% by weight of the total composition of alcohol. For example, the alcohol of the above soap composition may be isopropyl alcohol. In an example embodiment, the vinegar includes 5% by weight of the vinegar composition of acetic acid. Further, in an example embodiment, the isopropyl alcohol has 99.9% strength.

Additionally or optionally, the above soap composition may further include 60% by weight of the total composition of vinegar.

Therefore, a composition of the soap as described above is represented in Table-3 below.

TABLE 3

| Constituent | Range of proportion |
|---|---|
| Surfactant | 10% by weight of the total composition |
| Sugar solution | 20% by weight of the total composition |
| Alcohol | 10% by weight of the total composition |
| Vinegar (optional) | 60% by weight of the total composition |

According to an aspect of the disclosure, yet another soap composition is provided. This soap composition may include 75% by weight of the total composition of vinegar, 5% by weight of the total composition of isopropyl alcohol, and 15% by weight of the total composition of surfactants. In an example embodiment, the vinegar includes 5% by weight of the vinegar composition of acetic acid. Further, in an example embodiment, the isopropyl alcohol has 99.9% strength.

Additionally or optionally, the above soap composition may further include 5% by weight of the total composition of a sugar solution.

Therefore, a composition of the soap as described above is represented in Table-4 below.

TABLE 4

| Constituent | Range of proportion |
|---|---|
| Vinegar | 75% by weight of the total composition |
| Isopropyl Alcohol | 5% by weight of the total composition |
| Surfactant | 15% by weight of the total composition |
| Sugar solution (optional) | 5% by weight of the total composition |

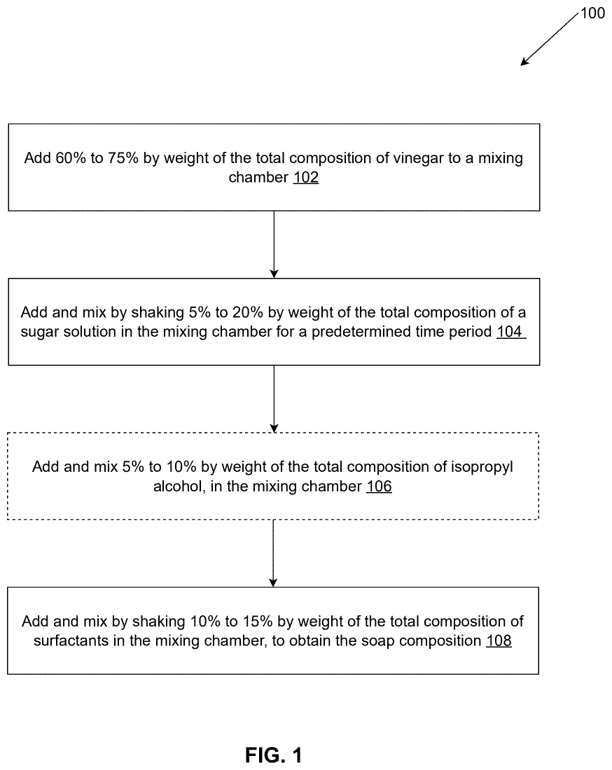

Referring now to FIG. 1, a flowchart of a process 100 of producing a soap composition is illustrated, in accordance with an aspect of the disclosure. The process 100 is explained via various steps, as described below.

At step 102, a first predefined weight of the total composition of vinegar may be added to a mixing chamber. The mixing chamber may include a container that may be configured to be agitated manually or through electrical or hydraulic power. By agitating, or simply shaking, the contents inside the mixing chamber are combined and thoroughly mixed to form a homogeneous mixture. As described above, the first predefined weight of the total composition of vinegar may be selected from a range of 60% to 75% by weight of the total soap composition. In an embodiment, the first predefined weight of vinegar may be 60% by weight of the total soap composition. In another embodiment, the first predefined weight of vinegar may be 70% by weight of the total soap composition.

At step 104, a second predefined weight of the total composition of a sugar solution may be added and mixed in the mixing chamber by shaking for a predetermined time period. Or, the sugar solution may be mixed in the mixing chamber until foam is formed on the surface of the mixture. As described above, the second predefined weight of the total composition of sugar solution may be selected from a range of 5% to 20% by weight of the total soap composition. In an embodiment, the second predefined weight of sugar solution may be 20% by weight of the total soap composition. In another embodiment, the second predefined weight of sugar solution may be 5% by weight of the total soap composition.

In an embodiment, additionally or optionally, at step 106, a third predefined weight of the total composition of isopropyl alcohol may be added and mixed in the mixing chamber. For example, the step 106 may be initiated when the foam formed on the surface of the mixture has settled down. To this end, for example, the step 106 may be initiated after waiting for 2 minutes after the completion of the step 104. As described above, the third predefined weight of the total composition of isopropyl alcohol may be selected from a range of 5% to 10% by weight of the total soap composition. In an embodiment, the third predefined weight of isopropyl alcohol may be 10% by weight of the total soap composition. In another embodiment, the third predefined weight of isopropyl alcohol may be 5% by weight of the total soap composition.

At step 108, a fourth predefined weight of the total composition of surfactants may be added and mixed by shaking in the mixing chamber, to obtain the soap composition. As described above, the fourth predefined weight of the total composition of surfactants may be selected from a range of 10% to 15% by weight of the total soap composition. In an embodiment, the third predefined weight of surfactants may be 10% by weight of the total soap composition. In another embodiment, the fourth predefined weight of surfactants may be 15% by weight of the total soap composition.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

1-15. (canceled)

16: A soap composition comprising:
vinegar; and
surfactants.

17: The soap composition of claim 16, further comprising isopropyl alcohol, wherein the composition is defined as being:
60% by weight of the total composition of vinegar;
10% by weight of the total composition of isopropyl alcohol; and
10% by weight of the total composition of surfactants.

18: The soap composition of claim 17, further comprising:
20% by weight of the total composition of a sugar solution.

19: The soap composition of claim 18, wherein the sugar solution comprises a mixture of water and sugar, wherein the sugar is fructose.

20: The soap composition of claim 19, wherein sugar is derived from starch of corn.

21: The soap composition of claim 16, further comprising a sugar solution, wherein the composition is defined as being:
60% by weight of the total composition of vinegar;
10% by weight of the total composition of surfactants; and
20% by weight of the total composition of a sugar solution.

22: The soap composition of claim 21, further comprising:
10% by weight of the total composition of alcohol.

23: The soap composition of claim 22, wherein the alcohol is isopropyl alcohol.

24: The soap composition of claim 16, further comprising a sugar solution, wherein the composition is defined as being:
60% to 75% by weight of the total composition of vinegar;
5% to 20% by weight of the total composition of a sugar solution; and
10% to 15% by weight of the total composition of surfactants.

25: The soap composition of claim 24, further comprising:
5% to 10% by weight of the total composition of isopropyl alcohol.

26: The soap composition of claim 25, wherein the vinegar comprises 5% by weight of the vinegar composition of acetic acid.

27: The soap composition of claim 25, wherein the isopropyl alcohol has 99.9% strength.

28: A soap composition comprising:
10% by weight of the total composition of surfactants;
20% by weight of the total composition of a sugar solution; and
10% by weight of the total composition of alcohol.

29: The soap composition of claim 28, further comprising:
60% by weight of the total composition of vinegar.

30: A process of producing a soap composition comprising the steps of:
adding 60% to 75% by weight of the total composition of vinegar to a mixing chamber,
adding and mixing by shaking 5% to 20% by weight of the total composition of a sugar solution in the mixing chamber for a predetermined time period; and
adding and mixing by shaking 10% to 15% by weight of the total composition of surfactants in the mixing chamber, to obtain the soap composition.

31: The process of claim 30 further comprising:
prior to adding the surfactants, adding and mixing 5% to 10% by weight of the total composition of isopropyl alcohol, in the mixing chamber.
